(19) United States
(12) Patent Application Publication
(10) Pub. No.: US 2011/0144962 A1
(43) Pub. Date: Jun. 16, 2011

(54) GEOSPATIAL MODELING SYSTEM PROVIDING ENHANCED FOLIAGE VOID REGION INPAINTING FEATURES AND RELATED METHODS

(75) Inventors: Steven G. Blask, Melbourne, FL (US); Harlan Yates, Melbourne, FL (US); Patrick Kelley, Palm Bay, FL (US); Mark Rahmes, Melbourne, FL (US); Anthony O'Neil Smith, Melbourne, FL (US)

(73) Assignee: Harris Corporation, Melbourne, FL (US)

(21) Appl. No.: 12/635,839

(22) Filed: Dec. 11, 2009

(51) Int. Cl. G06G 7/48; G01V 3/38

(52) U.S. Cl. 703/6; 702/5

(57) ABSTRACT

A geospatial modeling system may include a geospatial model database and a processor cooperating with the geospatial model database. The processor may be configured to determine void regions in a geospatial data set including foliage data points and bare earth data points, where each void region has a boundary and at least one bare earth data point therein. The processor may also be configured to inpaint additional bare earth data points into each void region based upon bare earth data points outside the boundary and the at least one bare earth data point therein.

### FIELD OF THE INVENTION

The present invention relates to the field of topographical modeling, and, more particularly, to geospatial modeling systems and related methods.

### BACKGROUND OF THE INVENTION

Topographical models of geographical areas may be used for many applications. For example, topographical models may be used in flight simulators and for planning tactical missions. Furthermore, topographical models of man-made structures (e.g., cities) may be extremely helpful in applications such as cellular antenna placement, urban planning, disaster preparedness and analysis, and mapping, for example.

Various types and methods for making topographical models are presently being used. One common topographical model is the digital elevation map (DEM). A DEM is a sampled matrix representation of a geographical area which may be generated in an automated fashion by a computer. In a DEM, coordinate points are made to correspond with a height value. DEMs are typically used for modeling terrain where the transitions between different elevations (e.g., valleys, mountains, etc.) are generally smooth from one to a next. That is, DEMs typically model terrain as a plurality of curved surfaces and any discontinuities therebetween are thus “smoothed” over. Thus, in a typical DEM no distinct objects are present on the terrain.

One particularly advantageous 3D site modeling product is RealSite® from the present Assignee Harris Corp. The RealSite® system may be used to register overlapping images of a geographical area of interest, and extract high resolution DEMs using stereo and nadir view techniques. The RealSite® system provides a semi-automated process for making three-dimensional (3D) topographical models of geographical areas, including cities, that have accurate textures and structure boundaries. Moreover, RealSite® models are geospatially accurate. That is, the location of any given point within the model corresponds to an actual location in the geographical area with very high accuracy. The data used to generate RealSite® models may include aerial and satellite photography, electro-optical, infrared, and light detection and ranging (LIDAR), for example.

Another advantageous approach for generating 3D site models is set forth in U.S. Pat. No. 6,654,690 to Rahmes et al., which is assigned to the present Assignee and is hereby incorporated herein in its entirety by reference. This patent discloses an automated method for making a topographical model of an area including terrain and buildings thereon based upon randomly spaced data of elevation versus position. The method includes processing the randomly spaced data to generate gridded data of elevation versus position conforming to a predetermined position grid, processing the gridded data to distinguish building data from terrain data, and performing polygon extraction for the building data to make the topographical model of the area including terrain and buildings thereon.

Still another advantageous geospatial modeling system is set forth in U.S. Patent Pub. No. 2008/0273759 to Rahmes et al., which is also assigned to the present Assignee and is hereby incorporated herein in its entirety by reference. This reference discloses a geospatial modeling system which includes a geospatial model database and a processor. The processor cooperates with the geospatial model database for inpainting data into at least one void in geospatial model terrain data based upon propagating contour data from outside the at least one void into the at least one void.

While such systems are particularly advantageous for filling missing data in void regions of a geospatial data set, further void region filling techniques may be desirable in some implementations.

### SUMMARY OF THE INVENTION

In view of the foregoing background, it is therefore an object of the present invention to provide a system and related methods for enhanced void region inpainting in geospatial data sets.

This and other objects, features, and advantages are provided by a geospatial modeling system which may include a geospatial model database and a processor cooperating therewith. The processor may be configured to determine void regions in a geospatial data set including foliage data points and bare earth data points, where each void region has a boundary and at least one bare earth data point therein. The processor may also be configured to inpaint additional bare earth data points into each void region based upon bare earth data points outside the boundary and the at least one bare earth data point therein. As such, the system advantageously provides enhanced accuracy when inpainting foliage void regions.

The processor may be configured to inpaint additional bare earth data points into each void region by propagating bare earth contour values from outside the boundary. Additionally, the processor may be configured to validate bare earth data points within the boundaries based upon a peak threshold. More particularly, the processor may be configured to validate each bare earth data point by comparing a corresponding height histogram with the peak threshold. By way of example, the peak threshold may comprise a minimum peak height threshold, a peak width threshold, a peak-to-valley ratio, etc.

The geospatial data set may comprise a Geiger mode Light Detection and Ranging (LIDAR) data set, for example. The processor may be further configured to inpaint the void regions based upon the bare earth data points therein to generate a bare earth Digital Elevation Model (DEM). The geospatial modeling system may further include a display coupled to the processor.

A related geospatial modeling method may include determining void regions in a geospatial data set including foliage data points and bare earth data points using a processor, where each void region has a boundary and at least one bare earth data point therein. The method may further include inpainting additional bare earth data points into each void region using the processor and based upon bare earth data points outside the boundary and the at least one bare earth data point therein.

### BRIEF DESCRIPTION OF THE DRAWINGS

FIG. 1 is a schematic block diagram of a geospatial modeling system in accordance with the invention.

FIGS. 2 and 3 are flow diagrams illustrating geospatial modeling methods in accordance with the invention.

FIG. 4 is a bare earth digital elevation model (DEM) of a geospatial data set with void areas therein resulting from extraction of foliage data points from the geospatial data set.

FIG. 5 is a close up view of a void region of the DEM of FIG. 4 illustrating validation of bare earth data points within the void region by the system of FIG. 1.

FIG. 6 is a series of histograms and corresponding height values for the data points within void region of FIG. 5 generated by the system of FIG. 1.

FIG. 7 is a close up view of the void region of FIG. 5 after inpainting by the system of FIG. 1 based upon the validated bare earth data points therein.

FIG. 8 is a full screen view of the DEM of FIG. 4 after inpainting of the void regions therein using the approach illustrated in FIGS. 5-7.

FIG. 9 is a histogram graph showing original and Gaussian filtered histograms generated by the system of FIG. 1 in performing bare earth data point validation.

FIG. 10 is a histogram representing a difference between the original and Gaussian filtered histograms of FIG. 9.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout, and prime notation is used to indicate similar elements in alternative embodiments.

As will be appreciated by those skilled in the art, portions of the present invention may be embodied as a method, data processing system, or computer program product. Accordingly, these portions of the present invention may take the form of an entirely hardware embodiment, an entirely software embodiment, or an embodiment combining software and hardware aspects. Furthermore, portions of the present invention may be a computer program product on a computer-usable storage medium having computer readable program code on the medium. Any suitable computer readable medium may be utilized including, but not limited to, static and dynamic storage devices, hard disks, optical storage devices, and magnetic storage devices.

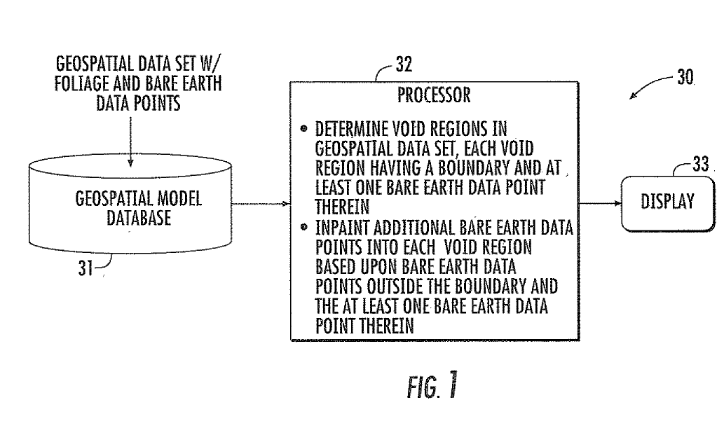

Referring initially to FIG. 1, a geospatial modeling system 30 is first described. The system 30 illustratively includes a geospatial model database 31 and a processor 32 cooperating with the geospatial model database. By way of example, the processor 32 may be implemented using the central processing unit(s) (CPU) of a PC, Mac, Sun, or other computer workstation and associated memory, etc., along with computer-readable instructions (i.e., software) stored in memory for causing the CPU to perform the various operation described herein. A display 33 is also illustratively coupled to the processor 32 for displaying various digital representations of the geospatial model data set, as will be discussed further below.

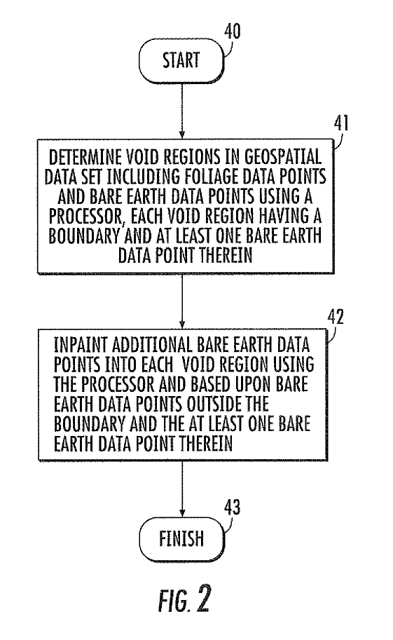

Referring additionally to FIG. 2, operation of the processor 32 is described beginning at Block 40. Generally speaking, the processor 32 is configured to determine void regions in a geospatial data set including foliage data points and bare earth data points, where each void region has a boundary and at least one bare earth data point therein, at Block 41. The processor 32 also is configured to inpaint additional bare earth data points into each void region based upon bare earth data points outside the boundary and the at least one bare earth data point therein, at Block 42, which concludes the method illustrated in FIG. 2 (Block 43). As such, the system 30 advantageously provides enhanced accuracy when inpainting foliage void regions, as it utilizes bare earth data points within the void regions to guide or steer the inpainting from outside the void region, as will be described further below.

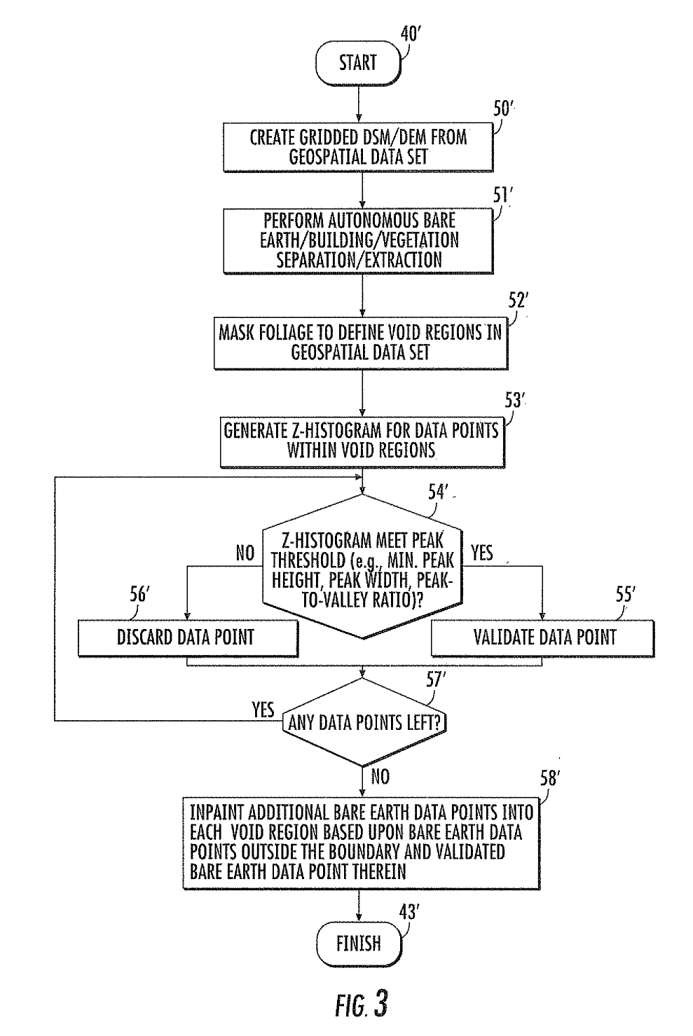

The foregoing will be further understood with reference to FIGS. 3-10. By way of example, the geospatial data set may be captured using various techniques such as stereo optical imagery, Light Detecting and Ranging (LIDAR), Interferometric Synthetic Aperture Radar (IFSAR), etc. Generally speaking, the data will be captured from overhead (e.g., nadir) views of the geographical area of interest by airplanes, satellites, etc., as will be appreciated by those skilled in the art. However, oblique images of a geographical area of interest may also be used in addition to (or instead of) the nadir images to add additional 3D detail to a geospatial model. The raw image data captured using LIDAR, etc., may be processed upstream from the geospatial model database 31 into a desired format, such as a digital surface model (DSM) or digital elevation model (DEM) with a given grid or post spacing, or this may be done by the processor 32, at Block 50′. By way of example, the above-described RealSite® system or the system set forth in U.S. Pat. No. 6,654,690 may be used for mapping raw data to a grid and generating the initial DSM/DEM. Of course, other suitable approaches may also be used.

In particular, a Geiger mode LIDAR return may be particularly advantageous for determining bare earth data points within foliage areas as opposed to linear mode LIDAR returns. As will be appreciated by those skilled in the art, Geiger mode LIDAR typically provides a greater number of returns than does a linear mode LIDAR capture. Moreover, a Geiger mode LIDAR capture typically provides greater penetration through foliage than does linear mode LIDAR. However, in different embodiments linear mode LIDAR or other data capture approaches may provide desired results.

As will be appreciated by those skilled in the art, a DEM generated from raw LIDAR data may include terrain (i.e., ground or bare earth), cultural features (i.e., manmade structures such as buildings, bridges, etc.), and foliage data. Yet, in some applications it is desirable to separate one of these types of data, such as the building or foliage data, from the remainder of the DEM data so that it can be viewed and/or processed individually. In particular, it is often desirable to create a bare earth DEM or DSM without cultural features or foliage, as will be appreciated by those skilled in the art. This may be done by “masking” those areas where foliage and/or cultural data features occur by extracting them from the data set, at Block 52′, which are then filled with simulated bare earth data to create void regions. By way of example, bare earth/cultural feature/foliage separation may be performed using advantageous approaches such as those set forth in U.S. Pat. Nos. 7,191,066, 7,376,513, and 7,292,941, for example, all of which are assigned to the present Assignee and are hereby incorporated herein in their entireties by reference.

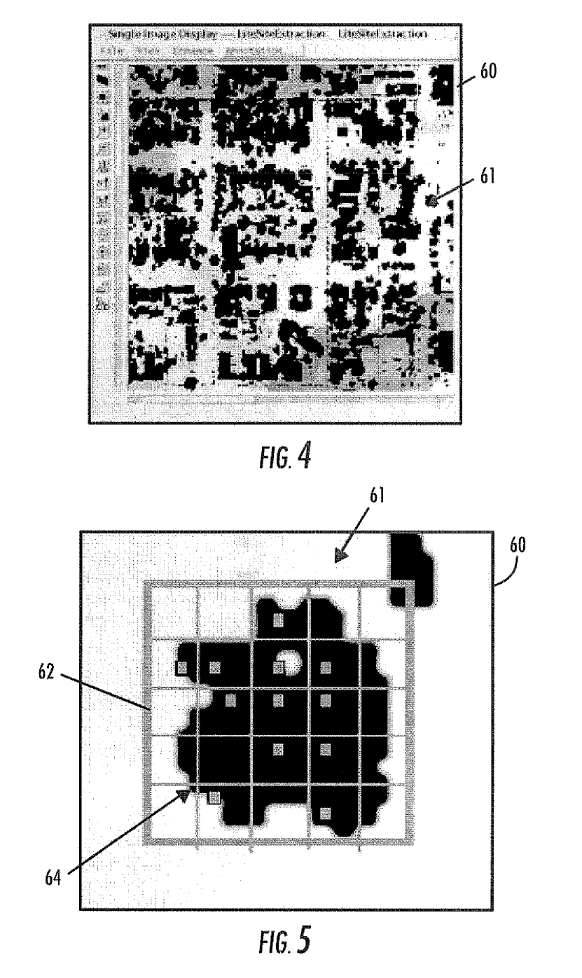

However, removal of data points may present problems with respect to accurately recreating the bare earth in the foliage areas or regions, particularly for large groups of relatively dense foliage (e.g., forests), as this may leave a large void in the DEM/DSM. One such void region 61 in DEM 60 from which foliage has been masked and extracted/removed is seen in FIGS. 4 and 5. Inpainting the void region 61 may sometimes result in less than desired accuracy because the inpainting is required to propagate, in the case of a large void, deep into the void, with each successive inpainting iteration getting progressively farther away from known reference points (i.e., the boundary points around the void).

In accordance with an advantageous aspect, the processor 32 advantageously uses validated bare earth data points within the void region 61 to inpaint data from the boundary into the void region. Validation of bare earth points within the void region 61 is performed to provide a confidence level that the returned data for grid locations within the void region are not low-lying foliage, noise, etc., or stated alternatively, false ground points. Generally speaking, validation of bare earth data points within the void region 61 is performed by comparing the data points to one or more peak thresholds to confirm that the given data point is within an expected range for a bare earth data point.

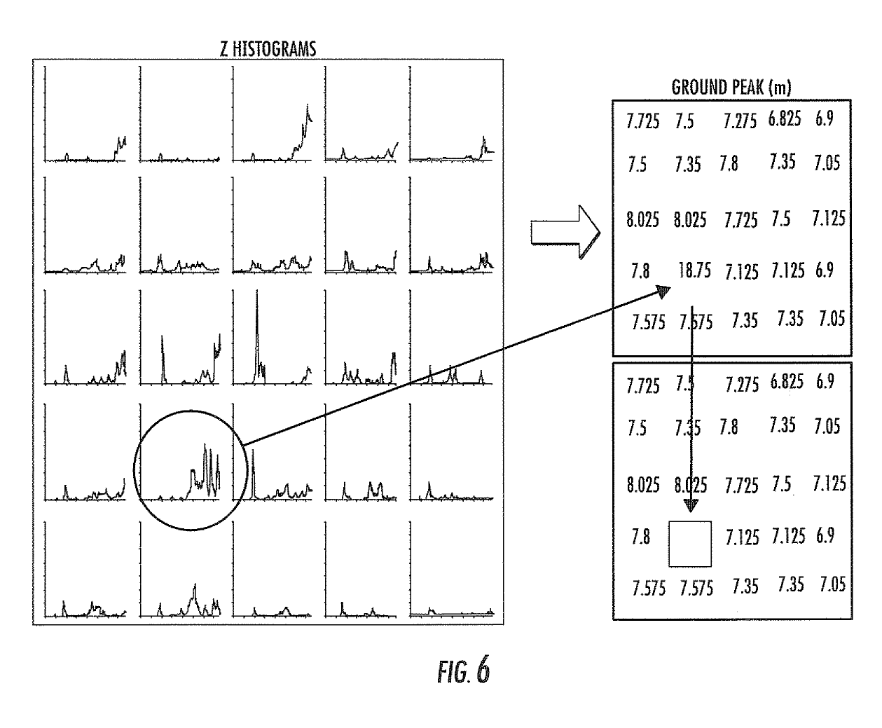

More particularly, one way by which this comparison may be performed by the processor 32 is to generate height (i.e., Z) histograms for each of the data points within the void region 61, as shown in FIG. 6. Each of the Z histograms corresponds to a respective point in the grid 62 shown in FIG. 5. Here, after the foliage void region 61 has been masked or extracted from the bare earth data, data points are validated and added back into their respective grid 62 locations if the Z histogram for the data point meets or complies with the prescribed peak thresholds for the given implementation, at Blocks 54′-55′. By way of example, upon generating the Z histogram for a given point, the processor 32 may use the highest peak in the histogram as a default point for comparison to the peak threshold(s), as will be discussed further below. If a data point is not validated, it is discarded and not used for inpainting, at Block 56′. The processor 32 proceeds to validate all of the points within the void region 61, and then performs the inpainting based upon the validated points, as noted above (Block 42′).

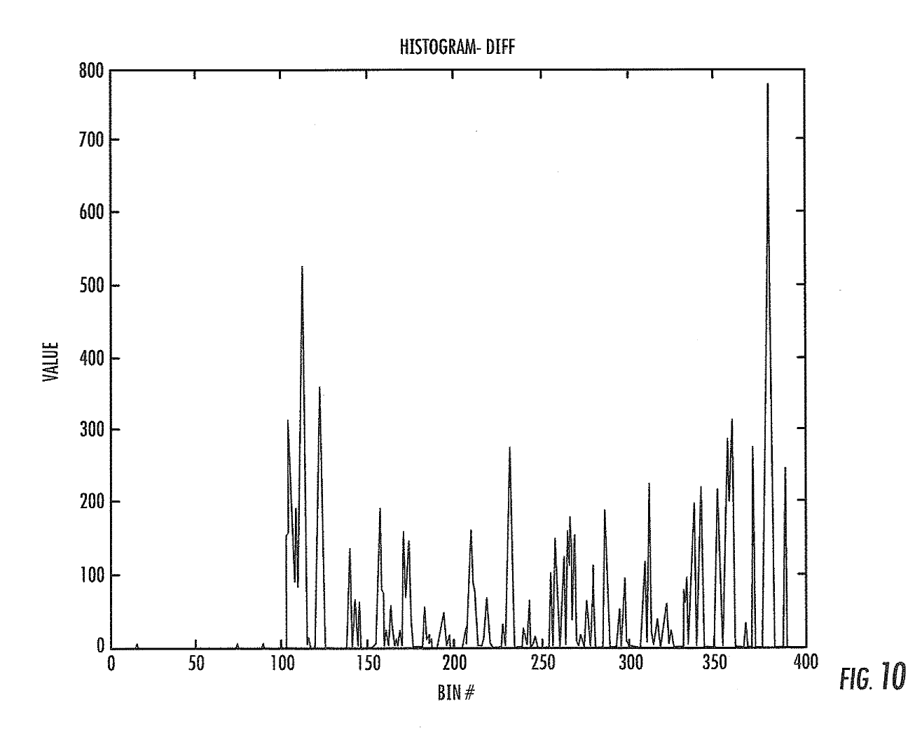

By way of example, one peak threshold which may be used is a minimum peak height threshold. It may be desirable to use such a threshold to make sure that the peak of the Z histogram in question is above a noise floor. For example, this determination may be made as a size (i.e., height) percentage of an overall histogram 100 for all of the points within the void region 61, such as the one shown in FIG. 9. For example, if the peak for the given Z histogram is less than 0.5% of the peak height of the overall histogram 100, then the given data point is considered to be below a noise threshold and is excluded. However, it should be noted that the threshold percentage may be higher or lower in different embodiments.

Another peak threshold that may be used in some embodiments is a peak width threshold. More particularly, the width of a Z histogram peak for a given data point may be an indicator that the data point is a spurious or noisy data point. That is, peaks that are particularly narrow may be indicative of noise. Thus, it may be desirable to determine if the width of the peak is at least equal to a certain percentage of the peak's height, such as 4%, for example, although higher or lower threshold percentages may be used in different embodiments.

Still another peak threshold that may be used is a peak-to-valley ratio. That is, the processor 32 may check to see if there is a sufficiently large peak-to-valley ratio on both sides of the peak. By way of an example, one exemplary peak-to-valley threshold ratio would one that is greater than 1.15. Stated alternatively, the peak should be at least 15% higher than the neighboring valley values, although here again other threshold values above or below this exemplary ratio may also be used in different embodiments.

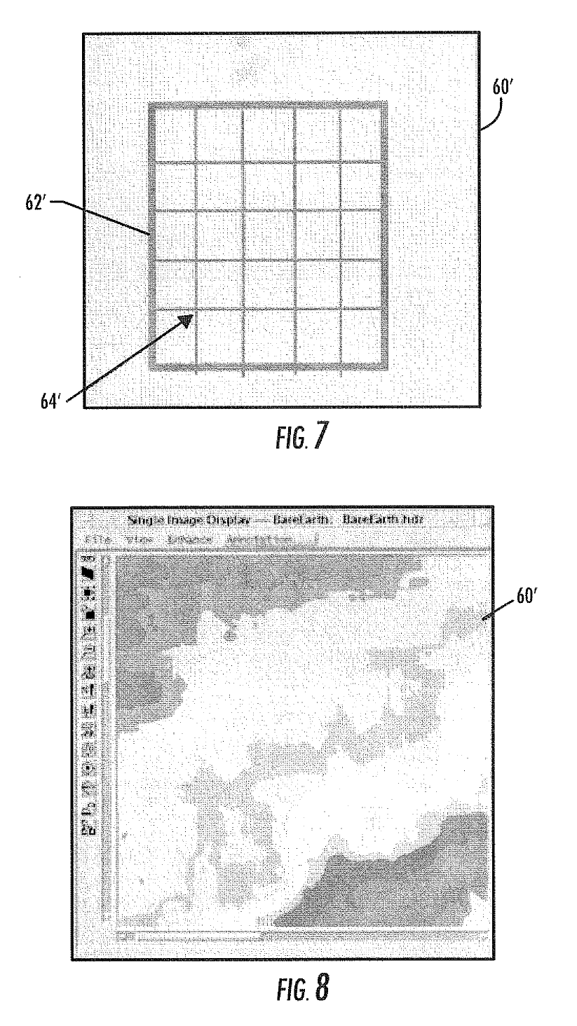

For the illustrated example, all of the points within the void region 61 meet all three of the above-described peak threshold parameters except for a pixel (i.e., data point) 64 in the forth row of the second column. As seen in the corresponding ground peak value grid map next to the Z histograms (i.e., which include the respective peak value from each of the histograms), the value of 18.75 m for this point well above the remaining peak heights for points in the void area 61. Thus, such a steep peak would violate the above-described peak width threshold, and this data point would therefore remain void until inpainting occurs, as shown in FIGS. 5 and 7.

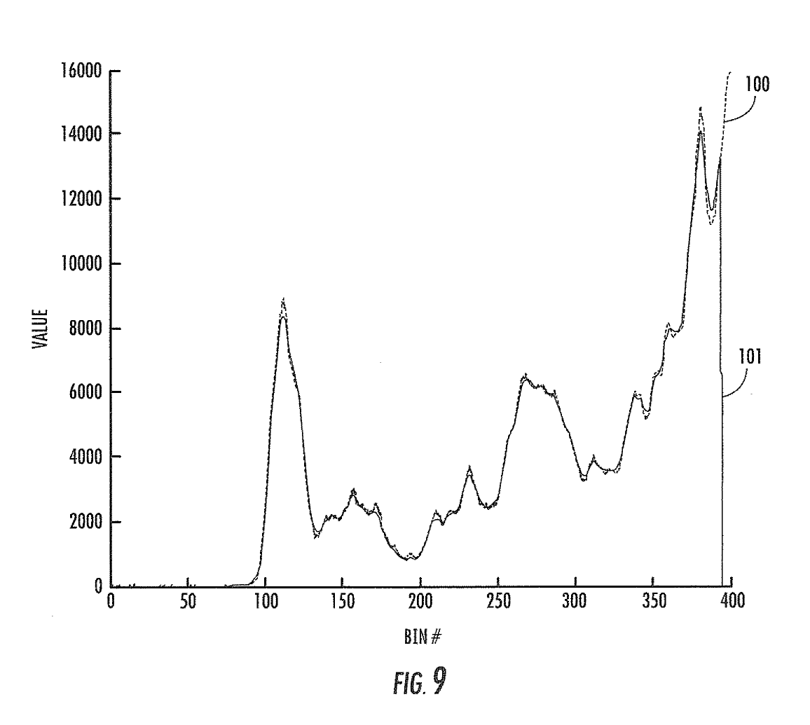

Here, the square pixels within the grid 62 indicate validated bare earth values for which no height change occurs during inpainting, whereas the pixel 64 (as well as other voided pixels) will be inpainted to the appropriate value based not only upon contour values from pixels surrounding the void area 61, but also based upon the validated bare earth pixels (i.e., the square pixels) within the void area itself and interspersed with the non-validated pixels. This thereby provides for significantly more reference points for inpainting operations, and accordingly significantly better accuracy, particularly where the size of the void area is relatively large, as will be appreciated by those skilled in the art. The final updated bare earth DEM 60′ after inpainting of all of the void regions using the above-described approach is shown in FIG. 8.

In accordance with another advantageous aspect, in some embodiments it may be desirable to generate a Gaussian filtered histogram 101 from the Z histogram 100 for each data point, as seen in FIG. 9, and instead use this Gaussian filtered histogram to determine local maxima for peak bins. For example, a peak difference threshold may be determined between the original Z histogram 100 and the Gaussian filtered histogram 101. By way of example, a normalized Gaussian window size of 1×13 with steps of 0.5, with sigma=1.0 may be used, although other parameters may be used in different embodiments, as will be appreciated by those skilled in the art. As such, if the peak difference is greater than or equal to (i.e., not less than) the above-noted threshold, then the processor 32 would use the original Z histogram 100 to determine the local maxima peak bins, and otherwise use the Gaussian filtered histogram 101. The differences between the original Z histogram 100 and the Gaussian filtered histogram 101 are shown in FIG. 10.

The processor 32 may advantageously perform the inpainting operations based upon non-linear inpainting techniques which propagate bare earth data points into each void region, i.e., by propagating bare earth contour values from outside the boundary into the remaining grid spaces in the void region 61 that do not have a validated bare earth value therein. By way of example, inpainting approaches such as those set forth in the above-noted U.S. Pat. Pub. No. 2008/0273759 and in U.S. Pat. Pub. No. 2009/0083005 to Allen et al., which is also assigned to the present Assignee and hereby incorporated herein in its entirety by reference.

Accordingly, the system 30 and methods described above advantageously provide a fully autonomous approach for detecting sparse valid ground returns, identifying true void regions, and robustly inpainting foliage-obscured areas to produce relatively high quality DEMs. This approach is particularly well suited for high resolution DEMs with a post spacing of 1 m or smaller, and may provide significantly enhanced results with a multi-look Geiger mode avalanche photo diode LIDAR capture techniques, for example, although other data capture approaches may also be used, as discussed further above.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A geospatial modeling system comprising:
a geospatial model database; and
a processor cooperating with said geospatial model database and configured to
determine void regions in a geospatial data set comprising foliage data points and bare earth data points, each void region having a boundary and at least one bare earth data point therein, and
inpaint additional bare earth data points into each void region based upon bare earth data points outside the boundary and the at least one bare earth data point therein.

2. The geospatial modeling system of claim 1 wherein said processor is configured to inpaint additional bare earth data points into each void region by propagating bare earth contour values from outside the boundary.

3. The geospatial modeling system of claim 1 wherein said processor is configured to validate bare earth data points within the boundaries based upon a peak threshold.

4. The geospatial modeling system of claim 3 wherein said processor is configured to validate each bare earth data point by comparing a corresponding height histogram with the peak threshold.

5. The geospatial modeling system of claim 3 wherein the peak threshold comprises a minimum peak height threshold.

6. The geospatial modeling system of claim 3 wherein the peak threshold comprises a peak width threshold.

7. The geospatial modeling system of claim 3 wherein the peak threshold comprises a peak-to-valley ratio.

8. The geospatial modeling system of claim 1 wherein the geospatial data set comprises a Geiger mode Light Detection and Ranging (LIDAR) data set.

9. The geospatial modeling system of claim 1 wherein said processor is further configured to inpaint the void regions based upon the bare earth data points therein to generate a bare earth Digital Elevation Model (DEM).

10. The geospatial modeling system of claim 1 further comprising a display coupled to said processor.

11. A geospatial modeling system comprising:
a geospatial model database; and
a processor cooperating with said geospatial model database and configured to
determine void regions in a geospatial data set comprising foliage data points and bare earth data points, each void region having a boundary and bare earth data points therein,
validate bare earth data points within the boundaries based upon a peak threshold, and
inpaint additional bare earth data points into each void region by propagating bare earth contour values from outside the boundary based upon the validated bare earth data points in the void region.

12. The geospatial modeling system of claim 11 wherein said processor is configured to validate each bare earth data point by comparing a corresponding height histogram with the peak threshold.

13. The geospatial modeling system of claim 11 wherein the peak threshold comprises at least one of a minimum peak height threshold, a peak width threshold, and a peak-to-valley ratio.

14. A geospatial modeling method comprising:
determining void regions in a geospatial data set comprising foliage data points and bare earth data points using a processor, each void region having a boundary and at least one bare earth data point therein; and
inpainting additional bare earth data points into each void region using the processor and based upon bare earth data points outside the boundary and the at least one bare earth data point therein.

15. The geospatial modeling method of claim 14 wherein inpainting comprises inpainting additional bare earth data points into each void region by propagating bare earth contour values from outside the boundary.

16. The geospatial modeling method of claim 14 further comprising validating bare earth data points within the boundaries based upon a peak threshold using the processor.

17. The geospatial modeling method of claim 16 wherein validating comprises validating bare earth data points by comparing a corresponding height histogram with the peak threshold.

18. The geospatial modeling method of claim 16 wherein the peak threshold comprises a minimum peak height threshold.

19. The geospatial modeling method of claim 16 wherein the peak threshold comprises a peak width threshold.

20. The geospatial modeling method of claim 16 wherein the peak threshold comprises a peak-to-valley ratio.
